(19) United States
(12) Patent Application Publication
(10) Pub. No.: US 2004/0104551 A1
(43) Pub. Date: Jun. 3, 2004

(54) Magnetic skateboard attachment system

(76) Inventor: Robert A. Jacobs, Campbell, CA (US)

Correspondence Address: GREGORY SMITH & ASSOCIATES, 3900 NEWPARK MALL ROAD, 3RD FLOOR, NEWARK, CA, 94560, US

(21) Appl. No.: 10/723,048

(22) Filed: Nov. 25, 2003

Related U.S. Application Data
(63) Continuation-in-part of application No. 10/339,726, filed on Jan. 8, 2003.
Application No. 10/339,726 is a continuation-in-part of application No. 10/011,328, filed on Oct. 22, 2001.
(60) Provisional application No. 60/429,099, filed on Nov. 25, 2002.

(51) Int. Cl. B62M 1/00

(52) U.S. Cl. 280/87.042

(57) ABSTRACT

Magnet housing assemblies embedded into the top surface of a skateboard are attracted to thin ferrous metal plates which are molded into a strap-on rubber sole that can be attached to each of a rider's shoes. The magnet housing assemblies increase the strength of the magnets housed within them to keep the skateboard firmly attached to the rider's feet giving the rider better control, stability and confidence throughout the airborne maneuvers. The size and position of the magnet housing assemblies with respect to the strap-on rubber sole attached to the bottom of the riders shoes allows the rider to use the standard positioning and movement of the feet that is required by most skateboard maneuvers.

### CROSS REFERENCE TO OTHER APPLICATIONS

This application claims the benefit of U.S. Provisional Application No. 60/429,099, filed Nov. 25, 2002. This application is also a continuation-in-part of U.S. Utility application Ser. No. 10/339,726, filed Jan. 8, 2003, which is a continuation-in-part of U.S. Utility application Ser. No. 10/011,328, filed Oct. 22, 2001. The specifications of these applications are hereby incorporated by reference in their entirety.

### FIELD OF INVENTION

This invention relates to skateboards, and more particularly to a skateboard that remains magnetically held against the riders shoes while the rider is performing maneuvers on the skateboard.

### BACKGROUND OF THE INVENTION

Skateboards have been in existence for many years, but in recent years skateboard maneuvers have become more intricate and precise and demand a greater level of control over the board. Some of today's more advanced maneuvers require the rider and board to become airborne. Since control inputs into the skateboard are transmitted through the rider's feet, a problem arises when both the rider and board become airborne. Since there is no reactive gravitational force holding the board against the rider's feet during the airborne portion of the maneuver, there is the danger of injury due to an uncontrolled landing. Currently, there is no good method for keeping the board in contact with the rider's feet. Skateboard riders have tried different solutions to solve this problem such as crouching and grabbing the board with one hand before becoming airborne. This solution is undesirable because it leaves the rider in a precarious and unstable position before and during the airborne maneuver. It also exposes the rider's fingers to injury during some types of maneuvers.

Prior art skateboards such as Atkinson, U.S. Pat. No. 4,179,134, provide a rigid removable trainer handle and brake apparatus. Whitacre, U.S. Pat. No. 4,289,325, provides a flexible cord that attaches to the front of the board. Both Mason/Allen, U.S. Pat. No. 4,887,825, and Younger, U.S. Pat. No. 5,221,111, provide flexible cords that attach to the center of the board. All have the same disadvantage in that they require the use of the rider's hands to hold the board against the rider's feet. This is insufficient for today's advanced skateboard maneuvers, which require that the rider's hands and arms are free to be used for balance and stability.

Another prior art skateboard Svetlov U.S. Pat. No. 5,769,438, describes a skateboard with magnets embedded in the surface, approximately at the center of the skateboard and magnets embedded in the soles of the rider's shoes. When the rider aligns the magnets in soles of the shoes with the magnets embedded in the center of the skateboard, the skateboard becomes magnetically attached to the rider's feet. This method has three disadvantages. The first being that even the strongest magnets currently available that can efficiently fit in the sole of a shoe, such as neodymium-iron-boron magnets, cannot by themselves provide the strength required to adequately hold the skateboard to the rider's feet throughout most modern skateboard maneuvers. For a skateboard to remain attached to a rider's feet throughout an airborne maneuver, the bond between the skateboard and the rider's shoe not only has to overcome the weight of the skateboard, but it must also overcome the strong G force induced from the sudden upward thrust of the rider's legs. This means that the magnets must overcome many times the static weight of the skateboard.

The second disadvantage of the above-mentioned patent is that the magnets embedded in the soles of the shoes must remain exactly aligned with the magnets embedded in the center of the skateboard. This does not allow the rider even a slight repositioning of the feet as is required by most skateboard maneuvers to maintain balance and control.

### SUMMARY OF THE INVENTION

The present invention uses a specially designed skateboard with 2 magnet housing assemblies embedded into the top surface of the body of the skateboard. These magnet housing assemblies are attracted to 2 thin ferrous metal plates which are molded into a strap-on rubber sole that can be attached to each of the rider's shoes. The magnet housing assemblies, by nature of their geometry and material, increase the strength of the magnets housed within them to a point sufficient enough to overcome the strong G forces induced from the sudden upward thrust of the rider's legs during an airborne maneuver. The increased magnetic strength of the magnet housing assemblies, keeps the skateboard firmly attached to the rider's feet giving the rider better control, stability and confidence throughout the airborne maneuvers. The size and position of the magnet-housing-assemblies with respect to the strap-on rubber sole attached to the bottom of the riders shoes allows the rider to use the standard positioning and movement of the feet that is required by most skateboard maneuvers. In addition the strap-on rubber soles can be attached to almost any athletic or skating shoe, so the rider does not have to buy a special pair of shoes with magnets molded into the sole. The present invention also allows the rider full use of the hands and arms for balance and stability rather than for holding the board to the feet throughout airborne maneuvers.

### BRIEF DESCRIPTION OF DRAWINGS

FIG. 1 is a perspective exploded view of a magnetic skateboard in accordance with the present invention.

FIG. 2A is a sectional view of the magnet housing assembly.

FIG. 2B is a sectional view of the magnetic skateboard in accordance with the present invention.

FIG. 3A is a perspective view of the specially molded strap-on sole.

FIG. 3B is a sectional view of the specially molded strap-on sole.

FIG. 3C is a perspective view of the specially molded strap-on sole strapped to a rider's shoe.

FIG. 4A is a perspective view of the placement of the rider's shoes with the specially molded strap-on soles on the magnetic skateboard.

FIG. 4B is a sectional view of the magnetic skateboard with the strap-on rubber sole rotated 90 degrees and engaged with the magnet housing assembly.

### REFERENCE NUMERALS IN DRAWINGS

1 Skateboard Deck 2 Milled Circular Hole

3 Wheel Trucks 4 Magnet Housing Assembly

5 Ferrous Metal Pole Piece 6 Circular Neodymium Iron Boron Magnet

7 Circular Through Hole 8 Outer Dia. of Ferrous Metal Pole Piece

9 Circular Counter bore 10 Cavity Shoulder

11 Retaining Rim 12 Wheel Truck Screws

13 Nut 15 Strap-On Rubber Sole

16 Rubber Body 17 Thin Ferrous Metal Plate

18 Straps 19 Rubber Rim

20 Rivets 21 Rider's Shoe

### DETAILED DESCRIPTION

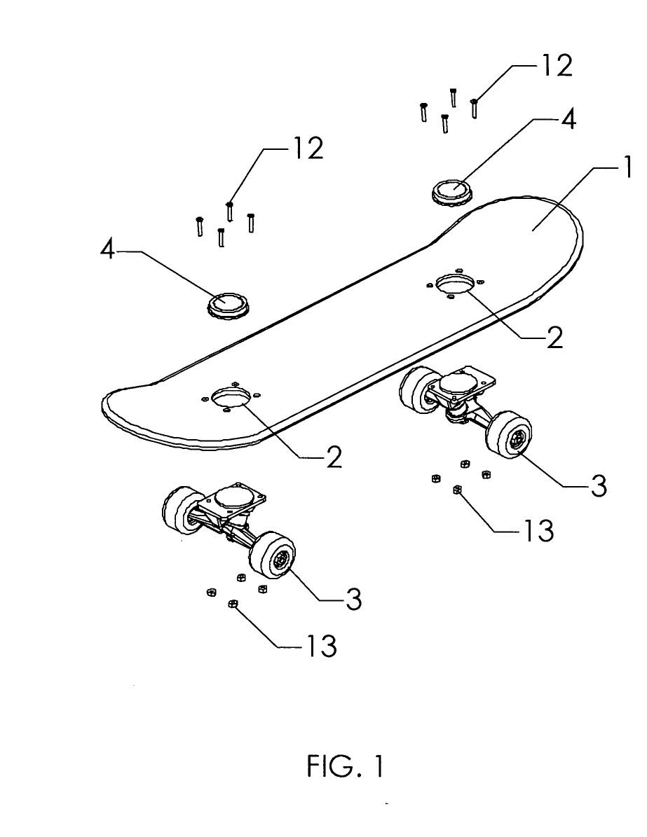

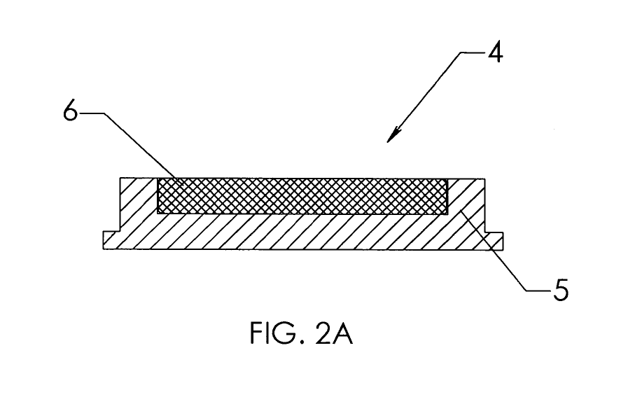

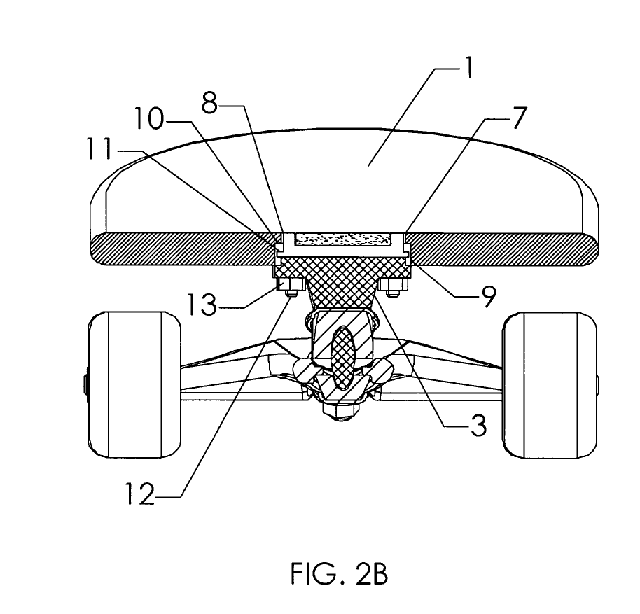

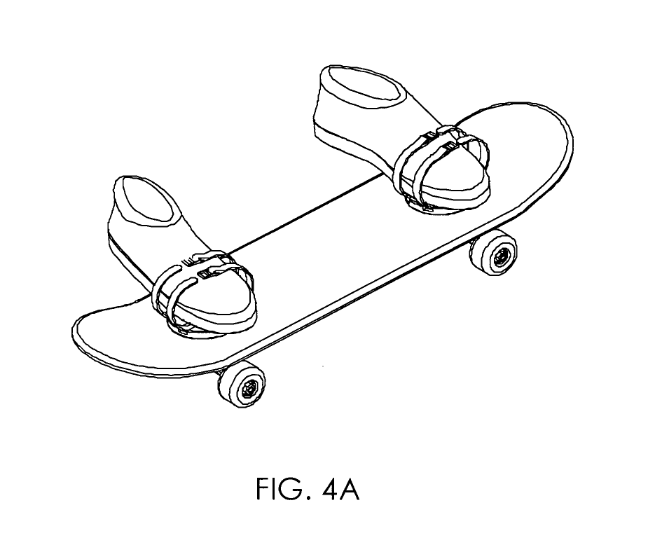

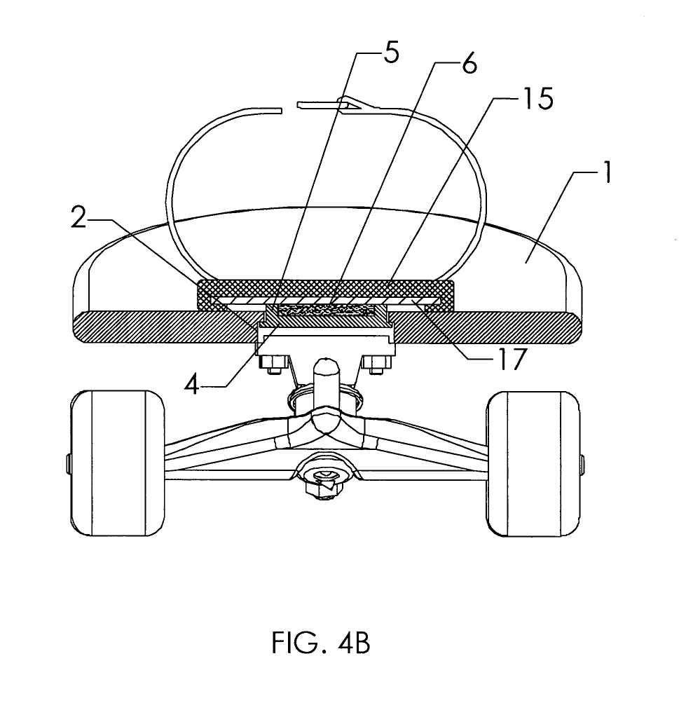

One embodiment of the present invention is illustrated in FIGS. 1, 2A, 2B, 3A, 3B, 3C, 4A and 4B. FIG. 1 shows an exploded view of a skateboard with a specially designed skateboard deck 1. The deck 1 has two or more circular cavities 2 milled through the deck and centered over the front and rear wheel trucks 3. Inserted into these milled circular cavities 2 are magnet housing assemblies 4. The magnet housing assemblies 4 are formed of a ferrous metal pole piece 5 and a circular neodymium-iron-boron magnet 6, as seen in FIG. 2A. FIG. 2B, a sectional view of the skateboard deck 1, shows how the magnet housing assembly 4 fits into the circular cavities 2 of the skateboard deck 1. The circular cavities 2 have a circular through-hole 7 and a circular counter-bore 9, which forms a small shoulder 10 at the top of the cavity 2. The circular through-hole 7 has a slightly larger diameter than the outer diameter 8 of the ferrous metal pole piece 5, and the circular counter-bore 9 has a slightly larger diameter than the outer diameter of the pole piece 5 retaining rim 11. The geometry of the circular cavity 2 and the ferrous metal pole piece 5 is such that the ferrous metal pole piece 5 can move up and down vertically within the cavity 2 due to the small gap between the cavity shoulder 10 and the pole piece retaining rim 11. The ferrous metal pole piece 5 is constrained from coming out of the bottom of the circular cavity 2 by the wheel truck 3, which is held in place by truck screws 12 and nuts 13. In the embodiment shown, the skateboard deck 1 is formed of laminated maple layers; however, any other wood, plastic or laminated fibrous or nonfibrous materials could be used. The magnet-housing-assemblies 4 enclosed in the circular cavities 2 act as a means to secure the skateboard deck 1 to the riders feet by attracting the thin ferrous metal plates 12, seen in FIG. 4B, embedded in a specially molded strap-on rubber sole 13, seen in FIG. 4A, strapped to the rider's shoe 21.

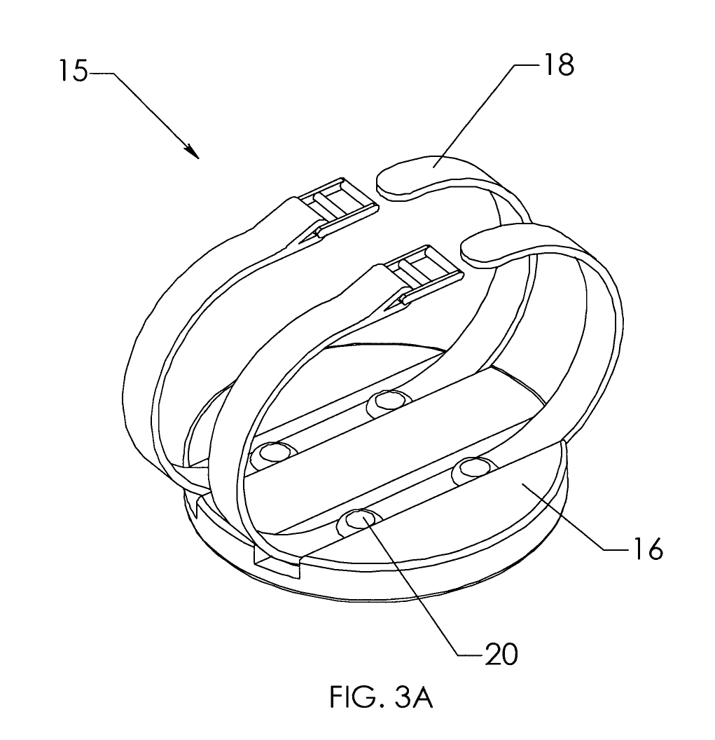

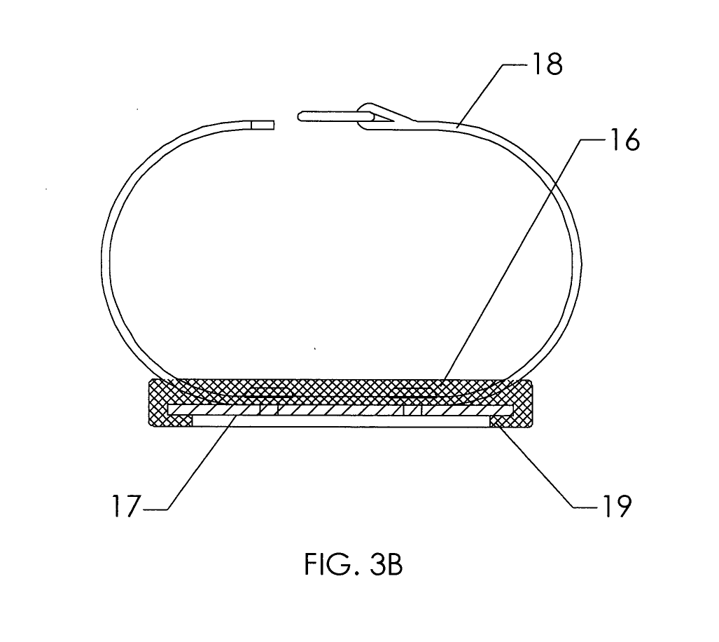

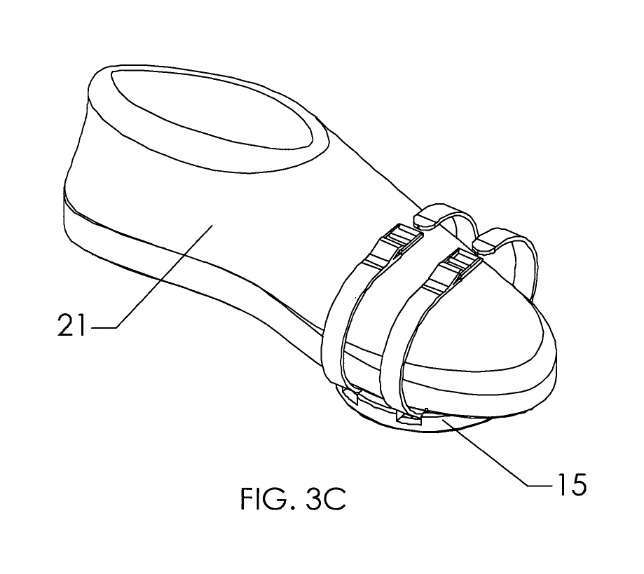

FIGS. 3A, 3B and 3C show the preferred embodiment of the specially molded strap-on rubber sole 15. The version shown is formed of a durable rubber material. This provides a slight resilience to allow some motion, while still firmly holding the plates 12 in place. Other materials, such as plastics, may also be used. The strap-on rubber sole 15 includes a rubber body 16, a thin ferrous metal plate 17 and two straps 18. FIG. 3B is a sectional view of the strap-on rubber sole 15 showing how the thin ferrous metal plate 17 is slightly recessed into the bottom of the rubber body 16. This recession forms a small rubber rim 19 on the bottom of the strap-on rubber sole 15 that serves to keep the thin ferrous metal plate 17 from coming in contact with the ground when the rider is not on the skateboard 1. In the embodiment shown, the straps 18 are molded into the rubber body 16 and secured to the thin ferrous plate 17 with rivets 20, however screws or some other fastening system could also be used.

In other embodiments of the inventions, one or both of the plates may be built into a pair of special shoes. The user would then wear the shoes without needing the additional strap on attachment. Depending on the holding strength needed, a version could be created with only a single plate, either molded into the shoe or as an attachment. This would hold the skateboard to one of the user's feet, but leave the other foot free.

Another variation would use additional magnets in additional magnetic housing assemblies. Alternately, a single magnetic housing assembly could be used to house multiple magnets.

Operation

The straps 18 of the strap-on rubber sole 15 are such that they can be securely strapped on to any conventional skating or athletic shoe 21, as seen in FIG. 3C. With the rubber sole 15 strapped on, the rider positions both shoes 21 over the magnet housing units 4 enclosed in the circular cavities 2 of the skateboard 1, as shown in 4A. FIG. 4B shows a sectional view of a single strap-on rubber sole 15 positioned over the magnet housing assembly 4 of the skateboard 1. As can be seen in FIG. 4B when the strap-on rubber sole 15 is positioned over the magnet housing assembly 4, the magnetic attraction to the thin ferrous metal plate 17 causes the magnet housing assembly 4 to rise up vertically out of the circular cavity 2 and make contact with the thin ferrous metal plate 17. With the strap-on rubber sole 15 in this position, the magnetic flux from the inner facing pole of the magnet 6 is focused through the ferrous metal pole piece 5, around the outer surface of the magnet 6, through the thin ferrous metal plate 17 and back into the opposite outward facing pole of the magnet 6, to make a complete magnetic circuit. The magnetic circuit created by the magnet housing assembly 4 provides a holding force much greater than that which could be provided by the magnet 6 alone. This is because the individual magnet 6 cannot carry the high fluxes that the ferrous metal pole piece 5 can. Therefore, the ferrous metal pole piece 5 focuses the magnetic flux so that the flux per unit area at the contact point of the thin ferrous metal plate 17 is higher than the flux per unit area at the interface between magnet 6 and ferrous metal pole piece 5. It is only through the use of the magnet housing assembly 4 that the skateboard deck 1 can remain securely attached to the rider's shoes 21 as the shoes 21 are thrust vertically upward during an airborne skateboard maneuver. Far less force is required to break the magnetic circuit if a rotational force is applied to the ferrous metal plate 17. A rider can assert this rotational force by rotating the shoe 21 heel over toe and bending at the ball of the foot. It is in this way that the rider can detach from the board at will, such as when one foot is needed to propel the skateboard forward or the rider needs to get clear of the board for safety reasons.

What is claimed is:

1. A skateboard for use with a shoe or shoe attachment, the skateboard comprising:
a skateboard deck,
a skateboard deck cavity located within said deck,
a ferrous pole piece sized and configured to fit within said skateboard deck cavity and having a magnet cavity located within said ferrous pole piece,
and a magnet located within said magnet cavity,
wherein said ferrous pole piece and magnet are connected with said skateboard deck and located at least partially within said skateboard deck cavity.

2. The skateboard of claim 1, further comprising a base plate attached to said ferrous pole piece.

3. The skateboard of claim 2, wherein said ferrous pole piece is attached to said base plate with a rivet.

4. The skateboard of claim 1, wherein said ferrous pole piece is cup-shaped and said magnet is located therein.

5. The skateboard of claim 1, wherein said magnet is neodymium-iron-boron.

6. The skateboard of claim 1, further comprising a second ferrous pole piece attached to said base plate and having a second magnet cavity located therein and a second magnet located within said second cavity.

7. The skateboard of claim 1, wherein said ferrous pole pieces are spaced apart such that a portion of said skateboard deck may be located between said ferrous pole pieces.

8. The skateboard of claim 1, wherein said ferrous pole piece is located proximate a front edge of said skateboard deck.

9. The skateboard of claim 1, further comprising:
a second ferrous pole piece sized and configured to fit within a second skateboard deck cavity and having a second magnet cavity located within said second ferrous pole piece,
and a second magnet located within said second magnet cavity,
wherein said second ferrous pole piece and magnet are connected with said skateboard deck and located at least partially within said skateboard deck cavity.

10. The skateboard of claim 9, wherein said first ferrous pole piece is located proximate a front edge of said skateboard deck and said second ferrous pole piece is located proximate a back edge of said skateboard deck.

11. The skateboard of claim 9, wherein said second ferrous pole piece is located with an edge between 0 and 10 inches from a back edge of the skateboard deck.

12. The skateboard of claim 9, wherein said second ferrous pole piece located on an upturned portion of said skateboard deck.

13. The skateboard of claim 9, wherein said first ferrous pole piece is located with an edge between 0 and 10 inches from a front edge of the skateboard deck.

14. The skateboard of claim 9, wherein said first ferrous pole piece is located on a horizontal portion of said skateboard deck adjacent a first upturned portion and with a first edge between zero and 10 inches from a front edge of the skateboard deck, and wherein said second ferrous pole piece is located on a second upturned portion of said skateboard deck with an edge between zero and 10 inches from a rear edge of the skateboard deck.

15. An attachment for a shoe used with a skateboard having magnetic properties, the attachment comprising:
a ferrous metal plate,
an attachment body sized and configured to hold said ferrous metal plate,
a rim extending from said attachment body and located below said ferrous metal plate, said rim sized and configured to hold said ferrous metal plate within said attachment body,
and at least one strap extending from said attachment body and sized to fit around the foot of a user.

16. The attachment of claim 15, wherein said attachment body and rim are formed of rubber.

17. The attachment of claim 15, wherein ferrous metal plate is recessed into said attachment body.

18. The attachment of claim 15, wherein said at least one strap is attached to said ferrous metal plate with at least one rivet.

19. The attachment of claim 15, wherein said at least one strap is molded into the attachment body.

20. In combination:
a skateboard, comprising:
a skateboard deck,
a skateboard deck cavity located within said deck,
a ferrous pole piece sized and configured to fit within said skateboard deck cavity and having a magnet cavity located within said ferrous pole piece,
and a magnet located within said magnet cavity,
wherein said ferrous pole piece and magnet are connected with said skateboard deck and located at least partially within said skateboard deck cavity,
a shoe attachment, comprising:
a ferrous metal plate,
an attachment body sized and configured to hold said ferrous metal plate,
a rim extending from said attachment body and located below said ferrous metal plate, said rim sized and configured to hold said ferrous metal plate within said attachment body,
and at least one strap extending from said attachment body and sized to fit around the foot of a user,
wherein said magnet and ferrous pole piece providing sufficient attraction with said ferrous plate to keep said skateboard proximate the shoe attachment during normal aerial maneuvers.
